(19) United States
(12) Patent Application Publication
(10) Pub. No.: US 2017/0249450 A1
(43) Pub. Date: Aug. 31, 2017

(54) Device and Method for Authenticating a User

(71) Applicant: Telefonaktiebolaget LM Ericsson (publ), Stockholm (SE)

(72) Inventors: Matthew John Lawrenson, Bussigny (CH); Julian Charles Nolan, Pully (CH)

(21) Appl. No.: 15/508,502

(22) PCT Filed: Sep. 5, 2014
(86) PCT No.: PCT/SE2014/051022

§ 371 Date: Mar. 3, 2017

(51) Int. Cl. G06F 21/31; G06K 9/00; G06K 9/20; H04L 29/06

(52) U.S. Cl. CPC G06F 21/316; H04L 63/083; G06K 9/00355; G06K 9/2036

(57) ABSTRACT

A device (100) for authenticating a user (130) is provided, the device being configured to receive characters typed by the user using a keyboard (112) operable as input device for the device, and, for each typed character, acquire an image from a camera (120) configured for imaging the keyboard,determine which finger of a hand is used for typing the character, and derive a respective transformed character from the received typed character based on the finger (151-153) used for typing the character. The finger used for typing the character is determined by image processing. The camera may optionally be configured for imaging a reflection (163) of the keyboard by a cornea (162) of the user. By taking into account which fmgers are used for typing characters related to authentication or access control on a keyboard, such as passwords, an increased level of security for is achieved.

### TECHNICAL FIELD

The invention relates to a device for authenticating a user, a method of authenticating a user of a device, a corresponding computer program, and a corresponding computer program product.

### BACKGROUND

Passwords are an important part of access control and authenticating a user to a service. An effective password is commonly described as ‘strong’, meaning it is difficult for a computer to replicate. Passwords based on things a person experiences in their life, e.g., names, places, dates, and so forth, are often not strong as they can be easily predicted. A password is more likely to be strong if it contains random characters, non-alphanumeric characters, or a sequence of words, commonly referred to as passphrase.

However, it is often difficult to remember strong passwords, and the number of services requiring passwords means remembering a different one for each service, which is inconvenient for many people. The importance of using different passwords is that, if one password is compromised, other services cannot be accessed as they rely on different authentication information.

An often-used solution is to write passwords down, either on paper or in a computer file, which may optionally be password protected (e.g., password managers like 1Password). While this allows a person to use many different strong passwords, it adds the vulnerability that if a different person accesses the list, authentication information for other services is compromised. A further issue related to conventional password entry is that if a person is observed by an adversary while entering a password, the adversary may be able to replicate that password.

### SUMMARY

It is an object of the invention to provide an improved alternative to the above techniques and prior art.

More specifically, it is an object of the invention to provide an improved means of authentication of a user of a device, and in particular a means of authentication which has an increased level of security.

These and other objects of the invention are achieved by means of different aspects of the invention, as defined by the independent claims. Embodiments of the invention are characterized by the dependent claims.

According to a first aspect of the invention, a device for authenticating a user is provided. The device comprises processing means operative to receive at least one character typed by the user. The at least one character is typed using a keyboard which is operable as input device for the device. The processing means is further operative to, for each typed character, acquire an image from a camera configured for imaging the keyboard, determine which finger of a hand of the user is used for typing the character, and derive a respective transformed character from the received typed character. The finger which is used for typing the character is determined by analyzing the image, i.e., by image processing. The respective transformed character is derived based on the finger used for typing the character.

According to a second aspect of the invention, a method of authenticating a user of a device is provided. The method comprises receiving at least one character typed by the user. The at least one characters is typed using a keyboard operable as input device for the device. The method further comprises, for each typed character, acquiring an image from a camera configured for imaging the keyboard, determining which finger of a hand of the user is used for typing the character, and deriving a respective transformed character from the received typed character. The finger which is used for typing the character is determined by analyzing the image, i.e., by image processing. The respective transformed character is derived based on the finger used for typing the character.

According to a third aspect of the invention, a computer program is provided. The computer program comprises computer-executable instructions for causing a device to perform the method according to an embodiment of the second aspect of the invention, when the computer-executable instructions are executed on a processing unit comprised in the device.

According to a fourth aspect of the invention, a computer program product is provided. The computer program product comprises a computer-readable storage medium which has the computer program according to the third aspect of the invention embodied therein.

The invention makes use of an understanding that an increased level of security for authenticating a user of a device may be obtained by taking into account which fingers are used for typing characters related to authentication or access control on a keyboard. In particular, this applies to characters which are typed as part of a password.

In the present context, authenticating a user of a device is to be understood as receiving authentication information, such as a login name or a password typed by a user using a keyboard which is operable as input device, and processing the authentication information so as to determine whether the user is allowed to access a resource. Authentication information may be a login name and/or a password, each of which may be a word or a string of characters used for authentication to prove identity or access approval, and which should be kept secret from those not allowed access. A password may also be an access code, comprising numerical characters only, such as a Personal Identification Number (PIN), or a passphrase, i.e., a sequence of words or a text. To this end, authenticating a user of a device includes, but is not limited to:
Controlling access of a user to a computing device, such as a desktop or laptop computer, a tablet computer, a smartphone, or a mobile phone,
Controlling access of a user to an application which is executed on a computing device, such as an application utilizing a certificate of the user, an email or chat application, a password manager, or the like,
Controlling access of a user to a web based service, such as email, online banking, a social network,
Controlling access of a person to a secured area such as a room or building, and
Controlling access of a customer of a bank to an Automated Teller Machine (ATM) or cash machine for the purpose of retrieving money.

Accordingly, the term device is to be understood to include devices comprising keypads for access control, ATMs and cash machines, and the like, in addition to the computing devices exemplified hereinbefore.

Embodiments of the invention utilize a camera for capturing an image, for each typed character, the image showing which finger of a hand of the user is used for typing the character. That is, the image is captured around the time when the user types the character, i.e., hits or presses the key, or shortly before or after. If the user types multiple characters, e.g., when typing a password, several images are captured, one for each character. In the present context, the finger which is used for interacting with the user-interface element displayed in the touchscreen is understood to be one of the fingers of the human hand, i.e., one of index finger, middle finger, ring finger, pinky, and thumb, rather than a specific finger of a specific user. Optionally, embodiments of the invention may distinguish between fingers of the left hand and fingers of the right hand.

The solution described herein allows using passwords which can more easily be remembered but which may yield transformed passwords which are considered strong from a security point of view, i.e., passwords which are not simply dictionary words but contain modified or apparently random characters, a mixture of lower- and upper-case characters, or non-alphanumeric characters. As an example, whereas “summer” would be considered a weak password, “5uMm3R” (replacing “s” by “5”, “e” by “3”, and capitalizing some characters) provides an increased level security. However, such strong passwords are more difficult to remember.

Rather than requiring users to remember strong passwords, embodiments of the invention receive a password typed by a user and modify the password, character by character, to yield a ‘strong’ password, or at least a password with an increased level of security. This is achieved by deriving, for each typed character, a respective transformed character based on the finger which is used for typing the character. Thus, in addition to remembering the password, a user is required to reproduce the pattern of fingers used for typing the characters which make up the password, or login name, so as to successfully authenticate. For instance, one may envisage an embodiment of the invention which leaves a character typed with the index finger unchanged, i.e., each respective transformed character is identical to the typed character, but derives a respective transformed character for each character which is typed with the middle finger by capitalizing the typed character or, more general, changing the case of the typed character from upper case to lower case and vice versa. Using the example described above, if the user types “summer”, starting with his/her index finger and alternating between the index finger and the middle finger, the transformed password is “sUmMeR” (since every second character is typed using the middle finger, starting at the second character). The transformed password is considered ‘stronger’ as the typed password, yet the typed password is easy to remember. It is noted that the user does not need to have any knowledge about how a respective transformed character is derived, i.e., the specific transformation algorithm.

It will be appreciated that embodiments of the invention are not limited to the specific example of a transformation algorithm described hereinbefore, but may utilize any algorithm suitable for transforming at least a part of the characters supported by a keyboard, or part of the digits supported by a keypad, which is operable as input device for the device, into respective transformed characters, wherein the transformation algorithm is dependent on the finger used for typing the character. In other words, the typing finger is used as input to the transformation algorithm, in addition to the typed character.

Embodiments of the invention are advantageous in that the risk of security breaches due to passwords being observed when typed is reduced. This is the case since it is more difficult for an adversary watching the user typing his/her password to also remember which finger was used for typing each of the characters making up the password.

According to an embodiment of the invention, the respective transformed character is derived further based on an identity of the device. In other words, the transformation algorithm based on which the transformed character is derived uses the device identity, or information pertaining to the device identity or a type of the device, as an additional input. This is advantageous in that a device specific transformation algorithm may be used, thereby even further reducing the risk of security breaches due to passwords being observed when typed. Even if an adversary succeeds in learning, in addition to the password, which fingers where used for typing a password, authentication is likely fail unless the adversary uses the same device as the user. In particular, this is advantageous for authentication or access control for web services which may be accessed from a variety of devices, e.g., any computer with a web browser and an internet connection.

According to an embodiment of the invention, a respective transformed character is derived only if the typed character is entered as part of a password. Embodiments of the invention are particularly advantageous when used in relation to passwords being typed by users for authentication or access control. This is the case since typed passwords typically are not visible to users but are provided as input for authentication or access approval, i.e., the transformed characters are signaled or sent to an application being executed on the device or to an external entity, such as a server providing a service to the device.

According to an embodiment of the invention, a password field is displayed on a display which is operable as output device for the device, and the user types the at least one character into the password field. For instance, the user may type the characters into a password field of a login screen in order to gain access to a computer. Alternatively, the characters may be typed into a password field of an application being executed on the device, e.g., a screen server locking the screen, or a web page. Optionally, the respective transformed character is entered into the password field. That is, the respective transformed characters are entered into the password field instead of the typed characters. This is advantageous in that the application or service requiring authentication need not be aware of the fact that transformed characters are derived in accordance with embodiments of the invention. In particular, the application or service will only receive the transformed password which has an increased level of security as compared to the typed password.

According to an embodiment of the invention, the respective transformed character is derived using an algorithm which is associated with the finger used for typing the character. Preferably, this transformation algorithm is specific for the finger used for typing, i.e., different transformation algorithms are associated with different fingers of the human hand. Alternatively, a single transformation algorithm may be used, which derives the respective transformed character based on the typing finger. The algorithm may, e.g., be an arithmetic function or a hash function, or may be based on one or more look-up tables.

According to an embodiment of the invention, the camera is configured for imaging a reflection of the keyboard by a cornea of the user. That is, the image is captured by virtue of corneal imaging. Corneal imaging is a technique which utilizes a camera for imaging a person's cornea, e.g., that of the user of the device, for gathering information about what is in front of the person and also, owing to the spherical nature of the human eyeball, for gathering information about objects in a field-of-view wider than the person's viewing field-of-view. Such objects may potentially be outside the camera's field-of-view and even be located behind the camera. The technique is made possible due to the highly reflective nature of the human cornea, and also the availability of high-definition cameras in devices such as smartphones and tablet computers. The camera may, e.g., be front-facing camera of the type which is frequently provided with tablets and smartphones, or a webcam mounted in a display of a desktop computer or the display of a laptop computer, in particular if the webcam has a field-of-view which does not include the hand or hands of the user. Alternatively, rather than relying on corneal imaging, embodiments of the invention may acquire the image from a camera which is configured for imaging the keyboard in a direct manner. This may, e.g., be the case if the field-of-view of a webcam mounted in a display of a desktop computer or the display of a laptop computer is sufficiently wide such that the keyboard and the hand or hands of the user are in the field-of-view of the camera.

According to an embodiment of the invention, the device further comprises a touchscreen, and the keyboard is a virtual keyboard which is displayed on the touchscreen. Such touchscreen-based devices include, e.g., smartphones, mobile terminals, or tablet computers such as Apple's iPad or Samsung's Galaxy Tab, but may also include other types of devices such as built-in displays in cars or vending machines. A touchscreen is an electronic visual display which provides graphical information to the user and allows the user to input information to the device, or to control the device, by touching the screen. For devices like tablets and smartphones, the built-in camera typically has a field-of-view which is directed into substantially the same direction as the viewing direction of the touchscreen and is provided on the same face of the device as the touchscreen (commonly referred to as front-facing camera).

Even though advantages of the invention have in some cases been described with reference to embodiments of the first aspect of the invention, corresponding reasoning applies to embodiments of other aspects of the invention.

Further objectives of, features of, and advantages with, the invention will become apparent when studying the following detailed disclosure, the drawings and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIGS. 1a and 1b illustrate a device for authenticating a user, in accordance with an embodiment of the invention.

FIG. 2 illustrates deriving a transformed character, in accordance with embodiments of the invention.

FIG. 3 shows a device for authenticating a user, in accordance with another embodiment of the invention. FIG. 4 shows a device for authenticating a user, in accordance with a further embodiment of the invention.

FIG. 5 shows a device for authenticating a user, in accordance with yet another embodiment of the invention.

FIG. 6 shows a device for authenticating a user, in accordance with yet a further embodiment of the invention.

FIG. 7 shows a processing unit of a device for authenticating a user, in accordance with an embodiment of the invention.

FIG. 8 shows a method of authenticating a user, in accordance with an embodiment of the invention.

FIG. 9 shows a processing unit of a device for authenticating a user, in accordance with another embodiment of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully herein after with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

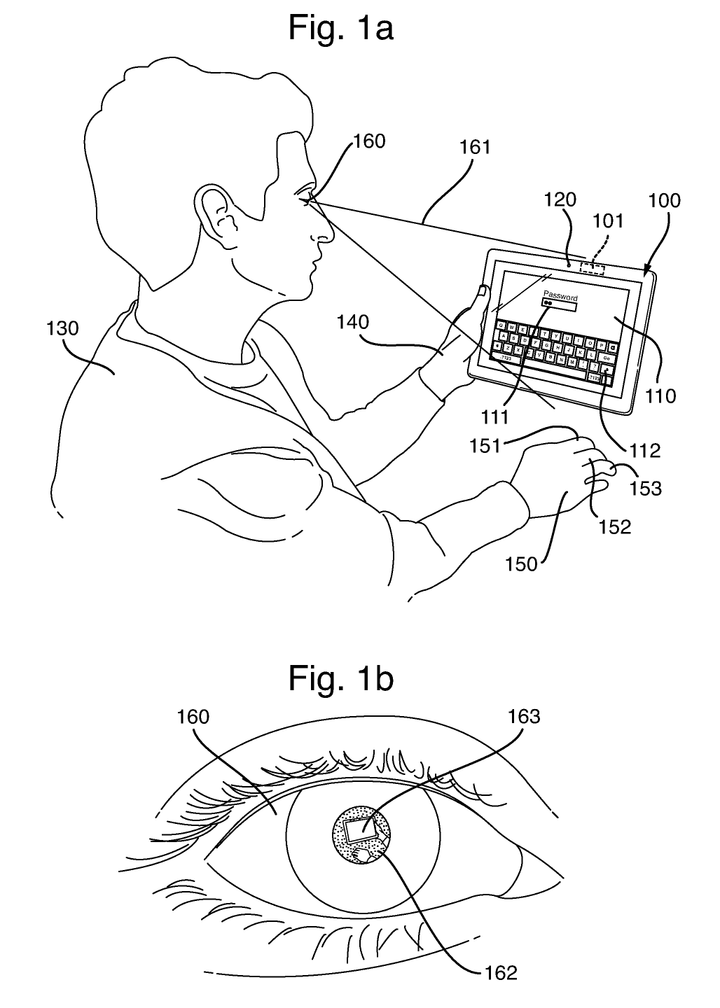

In FIG. 1a, a device 100 for authenticating user 130 is illustrated, in accordance with an embodiment of the invention. Device 100, in FIG. 1a illustrated as a tablet computer, comprises processing means 101, a touchscreen 110 as display, and a front-facing camera 120. Touchscreen 110 is operable as output device for device 100, i.e., for displaying graphical content such as user-interface elements, e.g., virtual buttons or keys, pictures, pieces of text, fields for entering text, or the like. Touchscreen 110, and the graphical objects displayed on it, is controlled by processing means 101, e.g., by an operating system or application being executed on processing means 101.

Even though device 100 is in FIG. 1a illustrated as being a tablet computer, or simply tablet, it may be any type of touchscreen-based device such as a smartphone, a mobile terminal, a User Equipment (UE), or the like, but may also be a built-in display of a type which is frequently found in cars or vending machines.

In FIG. 1a, touchscreen 110 is illustrated as displaying a password field 111, i.e., a text field for entering passwords, and a virtual keyboard 112 which is operable as input device for device 100, allowing user 130 to enter information and to control the operation of device 100. In particular, user 130 may use virtual keyboard 112 for typing a password, or other authentication information such as a login name, into password field 111.

To this end, processing means 101, and thereby device 100, is operative to receive at least one character typed by user 130 using keyboard 112. The characters may be any character supported by keyboard 112. Processing means 101 is further operative, for each typed character, to acquire an image from camera 120 which is configured for imaging keyboard 112, to determine which finger 151-153 of a hand 150 of user 130 is used for typing the character, i.e., the typing finger, and to derive a respective transformed character from the received typed character based on the finger used for typing the character, as is elucidated further below.

The image is acquired from camera 120 either in response to a keystroke or a key being touched or pressed, i.e., a still image, or from a time-stamped sequence of images or video footage. By also time-stamping the typed characters, each received character can be associated with a corresponding image showing which finger was used for typing the character. The acquired image captures user 130, or at least the hand 150 or finger 151-153 used for typing the character. Not that, throughout the present disclosure, the finger of a hand is understood to be one of the fingers of the human hand, i.e., one of thumb, index finger, ring finger, middle finger, or pinky, rather than a specific finger of a specific user. Embodiments of the invention may optionally distinguish between fingers of the left hand 140 and the right hand 150 of user 130.

Camera 120 is configured for imaging a reflection 163 of device 100, touchscreen 110, or at least keyboard 112, by a cornea 162 of an eye 160 of user 130. The technique of corneal imaging is made possible by the spherical nature of the human eyeball allowing gathering information about objects in a field of view 162 wider than the person's viewing field-of-view. Camera 120 is of a type referred to as front-facing and which frequently is encountered in smartphones and tablets. It will be appreciated that reflection 163 may alternatively arise from a contact lens placed on the surface of eye 160, or even from eyeglasses or spectacles worn in front of eye 160 (not shown in FIGS. 1a and 1b).

Processing means 101 is operative to determine which finger 151-153 of hand 150 is used for typing a received character by means of image processing, as is known in the art. More specifically, an image is first acquired from camera 120, either by requesting camera 120 to capture an image or by selecting an image from a sequence of images received from camera 120. Then, an eye 160 of user 130 is detected in the acquired image and cornea 162 is identified. Subsequently, reflection 163 of touchscreen 110 or virtual keyboard 112 is detected, e.g., based on the shape and visual appearance of touchscreen 110, i.e., the number and arrangement of the displayed user-interface elements, or the layout of keyboard 112. Finally, the acquired image, or at least a part of the acquired image showing at least one of the fingers of a hand of user 130 typing the character, is analyzed in order to determine which finger 151-153 of hand 150 is the typing finger. This may be achieved by identifying a number of biometric points related to the geometry of the human hand, and performing which measurements for identifying one or more fingers and optionally other parts of hand 150.

Processing means 101 may optionally be operative to derive a respective transformed character only if the typed character is entered as part of a password, i.e., typed into password field 111. That is, transformed characters are not derived for characters which are not part of a password. Whether a typed character is part of a password, or any other type of authentication information, can be determined based on the type of user-interface object into which user 130 types characters. For instance, processing means 101 may be operative to derive a respective transformed character only if a character is typed into a password field, such as password field 111. Password fields are typically different from general text entry fields, and characters entered into a password field are not displayed as characters but as dots or bullets, as is illustrated in FIG. 1a. Further, processing means 101 may be operative to only acquire the image and determine the typing finger if the typed character is entered as part of a password.

Processing means 101 may optionally be operative to provide the transformed character as input for authentication or access approval. That is, the transformed characters, making up a transformed password, are sent, or signaled, to an application being executed on processing means 101 and which requires authentication, or to an external network node requiring authentication, e.g., a server providing a service to device 100 over a communications network.

Even further, processing means 101 may be operative to enter the respective transformed character into password field 111. That is, the transformed character is entered instead of the typed character, which is intercepted. This is advantageous in that the application or service requiring authentication need not be aware of the fact that characters typed by user 130 while authenticating on device 100 are processed in accordance with embodiments of the invention. In particular, the application or service will only receive the transformed password which has an increased level of security as compared to the typed password.

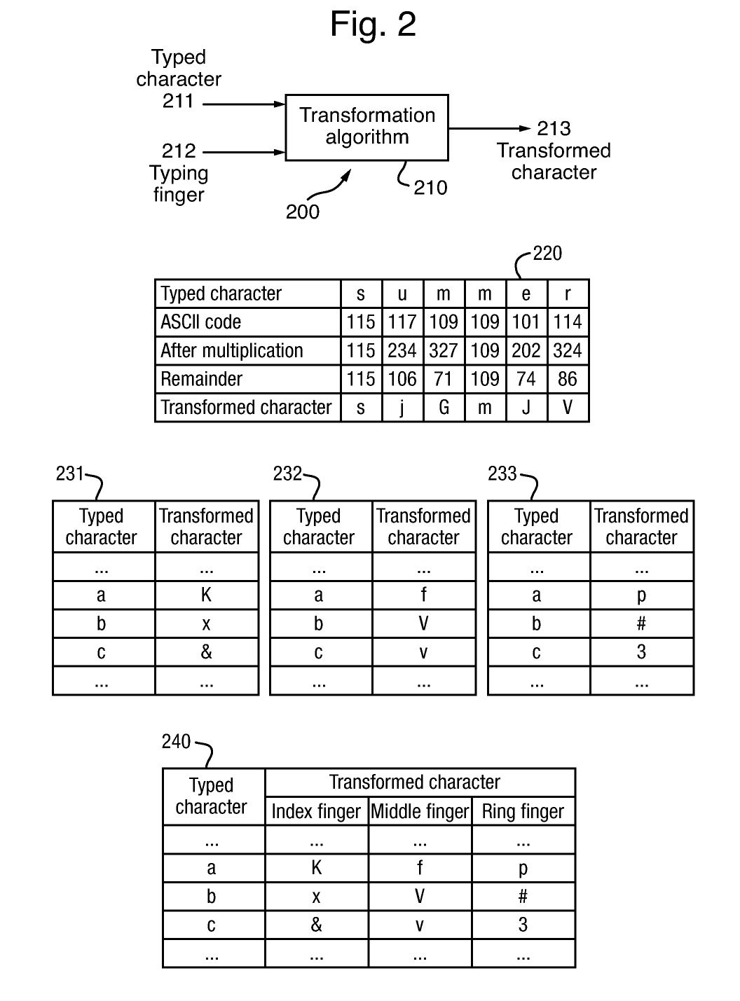

In the following, deriving a respective transformed character in accordance with embodiments of the invention is described in more detail with reference to FIG. 2, which shows a flow chart 200 illustrating a transformation algorithm 210. Transformation algorithm 210 may be implemented by processing means 101 described with reference to FIG. 1a, or processing means 401, 501, or 601, described with reference to FIGS. 4 to 6, respectively, which thereby are operative to derive a respective transformed character in accordance with an embodiment of the invention.

Transformation algorithm 210 is in FIG. 2 illustrated as receiving a typed character 211 and information pertaining to the typing finger 212 as input, and deriving a respective transformed character 213 as output. Note that it is assumed here that information identifying the typing finger 212 is correlated with the information identifying the typed character 211. Transformation algorithm 210 is preferably specific for the finger, i.e., it may comprise different algorithms which are associated with different fingers, as is elucidated further below. Alternatively, a single transformation algorithm 210 may be used which derives transformed characters which are specific for the typing finger. That is, for the same typed character 211 but different typing fingers 212, transformation algorithm derives distinct transformed characters 213. Transformation algorithm 210 may be any algorithm suitable for transforming at least a part of the characters supported by the keyboard operable as input device, such as keyboard 112, into respective transformed characters, wherein transformation algorithm 210 is dependent on the typing finger.

For instance, transformation function 210 may be an arithmetic function, i.e., a function involving operations such as addition, subtraction, multiplication, and division. As an example, transformation function 210 may derive the respective transformed character 213 by offsetting or multiplying the typed character 211 by an integer value which is associated with the finger 212 used for typing the character, in accordance with a character table associated with the keyboard. A character table is used for encoding characters available on a keyboard into integers, for the purpose of representing and processing characters and text in computers, communications networks, and software, as is known in the art. A well-known example is the American Standard Code for Information Interchange (ASCII) character table, which associates 128 specified characters—the numbers 0-9, the letters a-z and A-Z, some basic punctuation symbols, a blank space, and some control codes—with 7-bit binary integers (0 to 127). In the following, embodiments of the invention are exemplified using the ASCII character table, but one may easily envisage embodiments of the invention based on any other character table.

As an example, consider the password “summer” introduced above and reproduced in the first row of table 220 in FIG. 2. According to the ASCII character table, “summer” may be represented by a sequence of integers, the ASCII codes, shown in decimal representation in the second row of table 220. Now, according to an embodiment of the invention, a respective transformed character is derived for each typed character by applying an arithmetic operation to the typed character, or rather its ASCII code. For example, the respective ASCII code may be multiplied by “1” if the index finger is used for typing the character, by “2” if the middle finger is used for typing the character, and by “3” if the ring finger is used for typing the character.

Assuming that user 130 uses his/her index finger 151 for typing the first character (“s”), his/her middle finger 152 for typing the second character (“u”), his/her ring finger 153 for typing the third character (“m”), and repeats the sequence of fingers for all remaining characters of the password, the respective ASCII codes shown in the third row of table 220 are obtained. In order to take into account the limited size of the character table used, the results of the multiplication may further be divided by the size of the character table, 128 in the case of the ASCII character table, yielding respective remainders shown in the fourth row of table 220. The remainders are then used as ASCII codes for looking up the corresponding transformed characters in the character table, i.e., the reverse operation as the one performed for deriving the second row of table 220 from the first row is performed. The derived transformed characters are shown in the last row of table 220. Advantageously, the resulting password “sjGmJV” has an increased level of security, and is most likely considered ‘strong’, as it does not constitute a dictionary word.

It will be appreciated that embodiments of the invention are not limited to the specific arithmetic operations, integer values, or fingers, described hereinbefore. Rather, embodiments of the invention may be based on any arithmetic function which can be used for deriving a transformed character from a typed character based on the typing finger. For instance, rather than multiplying the ASCII code by an integer value, embodiments of the invention may use addition, subtraction, division, or any combination thereof.

As an alternative, transformation algorithm 210 may be a hash function. Hash functions can be used for transforming digital data of arbitrary size, e.g., a string of characters such as a password or passphrase, into digital data of fixed size (e.g., a string of fixed length), with slight differences in input data producing considerable differences in output data. To this end, embodiments of the invention may use a hash function 210 for deriving a respective transformed character 213, wherein hash function 210 uses information 212 identifying the typing finger as additional input.

As yet another alternative, transformation algorithm 210 may derive the respective transformed character 213 by looking up the transformed character in a table which is associated with the finger 212 used for typing the character. The transformed character 213 is preferably specific for the typing finger 212, i.e., different transformed characters are associated with different fingers. Accordingly, transformation algorithm 210 may utilize different tables which are associated with the different fingers of the human hand, e.g., tables 231-233 shown in FIG. 2 which may be associated with index finger 151, middle finger 152, and ring finger 153, respectively. Each of tables 231-233 comprises a first column of typed characters 211 and a second column of transformed characters 213. Transformation algorithm 210 derives a respective transformed character 213 from the received typed character 211 based on the finger 212 used for typing the character by selecting one of tables 231-233 which is associated with the typing finger 212, e.g., table 231 if index finger 151 is used for typing the character, looking up the typed character 211 in the first column of table 231, and using the corresponding character from the second column of table 231 as transformed character 213.

As an alternative, transformation algorithm 210 may utilize a single table having multiple columns of transformed characters, one for each finger of the human hand. For instance, table 240 is in FIG. 2 illustrated as comprising a first column of typed characters, and several additional columns being associated with one of index finger 151, middle finger 152, and ring finger 153, respectively. Accordingly, transformation algorithm 210 derives a respective transformed character 213 from the received typed character 211 based on the finger 212 used for typing the character by looking up the typed character 211 in the first column of table 240, selecting one of the columns of transformed characters in table 240 based on the typing finger 212, e.g., the second column if index finger 151 is used for typing the character, and using the corresponding character from the selected column of table 240 as transformed character 213.

It will be appreciated that tables 231-233 and 240, of which only parts are illustrated in FIG. 2, may comprise any characters which are supported by a keyboard used as input device for typing characters, such as virtual keyboard 112 illustrated in FIG. 1a. Tables 231-233 and 240, and in particular the associations between typed and transformed characters, may be generated randomly or according to a suitable algorithm or function, e.g., arithmetic functions as described hereinbefore with reference to table 220.

Further optionally, processing means 101 may be operative to derive the respective transformed character further based on an identity of device 100. That is, algorithm 210 takes further into account the identity of device 100, e.g., a serial number, an identity configured by user 130 or an operator of a communications network to which device 100 is connected, a network address of device 100 (e.g., a Media Access Control, MAC, address), or the like. Thereby, the transformed characters 213, and consequently the transformed password, are further dependent on the identity of the device at which user 130 attempts to authenticate. This is advantageous in that the risk of security breaches due to passwords being observed when typed is further reduced, in particular in relation to authentication or access control for web services which may be accessed from a variety of devices, e.g., any computer with a web browser and an internet connection.

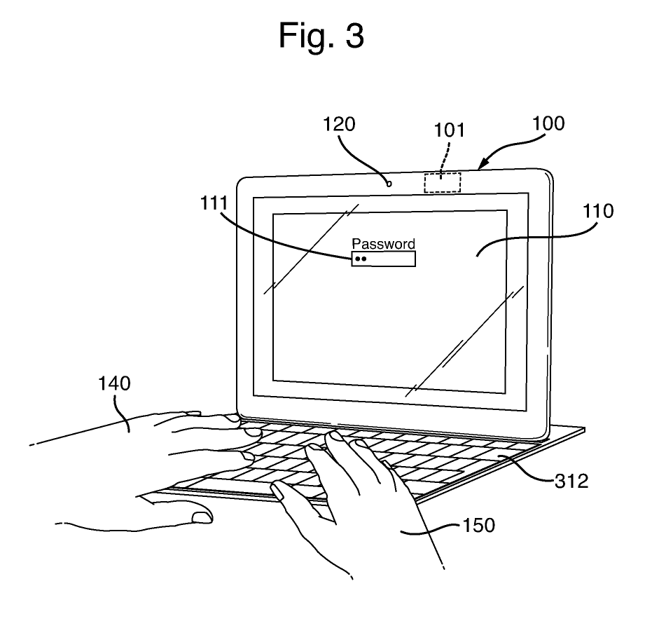

In the following, alternative embodiments of the device for authenticating a user are described with reference to FIGS. 3 to 6.

In FIG. 3, device 100 described with reference to FIG. 1a is illustrated in a different configuration. Similar to FIG. 1a, touchscreen 110 is in FIG. 3 illustrated as displaying a password field 111, i.e., a text field for entering passwords. However, in contrast to FIG. 1a an external keyboard 312 which is operable as input device for tablet 300 is illustrated in FIG. 3. User 130 may use keyboard 312 for typing a password, or other authentication information such as a login name, into password field 111.

External keyboards of the type illustrated in FIG. 3, such as keyboard 312, are available as accessories for tablets and smartphones and are typically configured for being connected to a computing device, such as tablet 100, by means of a wired connection, e.g., based on the Universal Serial Bus (USB) or Apple's Lightning bus, or a wireless connection such as Wireless Local Area Network (WLAN)/WiFi or Bluetooth.

In FIG. 4, a conventional desktop computer 400 is illustrated. Computer 400 comprises processing means 401 and is connected to a display 410 which is operable as output device for computer 400, and to a keyboard 412 which is operable as input device for computer 400. User 130 may use keyboard 412 for typing a password, or other authentication information such as a login name, into a password field displayed on display 410. Computer 400 is further connected to a camera, such as a webcam 420 which display 410 is provided with or an external webcam, which is configured for imaging keyboard 412, either directly or by means of corneal imaging, depending on the field-of-view of camera 420. It will be appreciated that display 410, keyboard 412, and camera 420, may be connected to computer 400 by any suitable interface, wired or wireless, as is known in the art.

Processing means 401, and thereby computer 400, is operative to receive at least one character typed by user 130 using keyboard 412, and for each typed character, acquire an image from camera 420, determine, by analyzing the image, which finger of a hand 140 or 150 of user 130 is used for typing the character, and derive a respective transformed character from the received typed character based on the finger used for typing the character. The respective transformed character is derived in accordance with what is described hereinbefore, in particular with reference to FIG. 2. To this end, processing means 401 is operative to implement an embodiment of transformation algorithm 210.

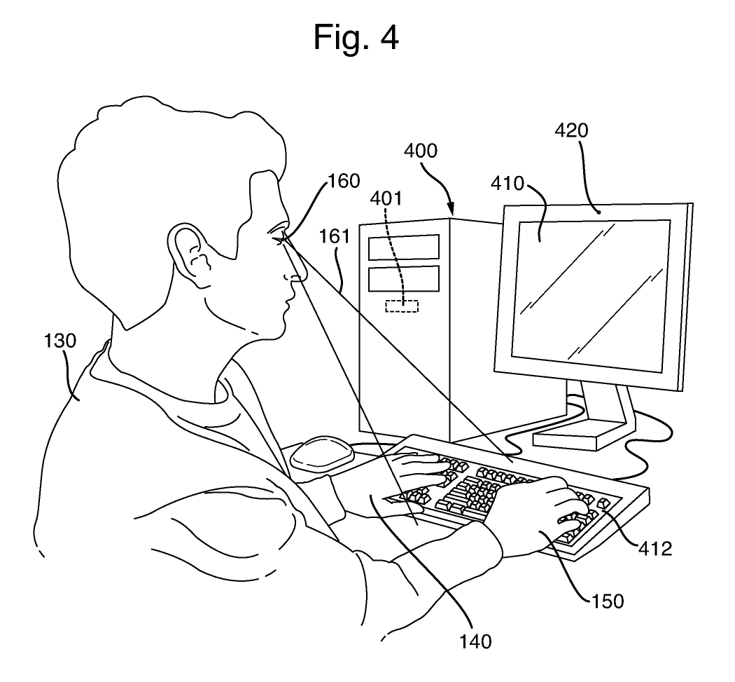

In FIG. 5, a laptop computer 500 is illustrated. Laptop 500 comprises processing means 501, a display 510 which is operable as output device for laptop 500, and a keyboard 512 which is operable as input device for laptop 500. User 130 may use keyboard 512 for typing a password, or other authentication information such as a login name, into a password field displayed on display 510. Laptop 500 may further comprise a camera, such as a webcam 520 which is configured for imaging keyboard 512, either directly or by means of corneal imaging, depending on the field-of-view of camera 520. Alternatively, laptop 500 may be connected to an external webcam which is configured for imaging keyboard 512, either directly or by means of corneal imaging. It will be appreciated that an external camera may be connected to laptop 500 by any suitable interface, wired or wireless, as is known in the art.

Processing means 501, and thereby laptop 500, is operative to receive at least one character typed by user 130 using keyboard 512, and for each typed character, acquire an image from camera 520, determine, by analyzing the image, which finger of a hand 140 or 150 of user 130 is used for typing the character, and derive a respective transformed character from the received typed character based on the finger used for typing the character. The respective transformed character is derived in accordance with what is described hereinbefore, in particular with reference to FIG. 2. To this end, processing means 501 is operative to implement an embodiment of transformation algorithm 210.

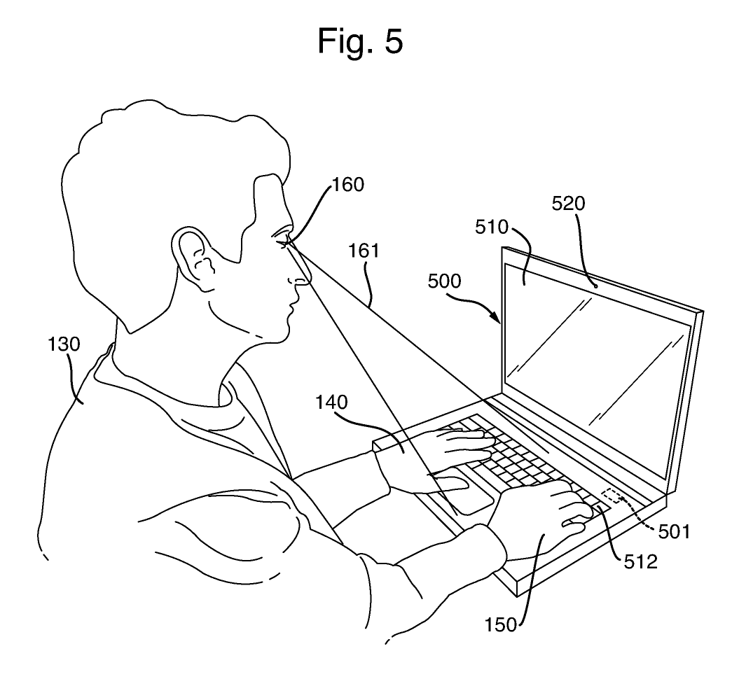

In FIG. 6, a device 600 for access control is illustrated. Device 600 comprises processing means 601 and a keypad 612 which is operable as input device for device 600. In contrast to keyboards 112, 312, 412, and 512, described hereinbefore, a keypad such as keypad 612 typically only supports the digits 0-9, and optionally some additional control buttons. User 130 may use keypad 612 for typing an access code, such as a PIN, which is a password comprising only the digits 0-9. Device 600 may further comprise a camera 620 which is configured for imaging keypad 612, either directly or by means of corneal imaging, depending on the field-of-view of camera 620. Alternatively, device 600 may be connected to an external camera which is configured for imaging keypad 612, either directly or by means of corneal imaging. It will be appreciated that an external camera may be connected to device 600 by any suitable interface, wired or wireless, as is known in the art.

Processing means 601, and thereby device 600, is operative to receive at least one digit typed by user 130 using keypad 612, and for each typed digit, acquire an image from camera 620, determine, by analyzing the image, which finger of a hand 150 of user 130 is used for typing the digit, and derive a respective transformed digit from the received typed digit based on the finger used for typing the digit. The respective transformed digit is derived in accordance with what is described hereinbefore, in particular with reference to FIG. 2. To this end, processing means 601 is operative to implement an embodiment of transformation algorithm 210. It will be appreciated that the embodiment of transformation algorithm 210 which is implemented by processing means 601 may need to be adapted to the limited character set supported by keypad 612, i.e., the ten digits 0-9.

It will be appreciated that embodiments of the invention may comprise different means for implementing the features described hereinbefore, and these features may in some cases be implemented according to a number of alternatives. For instance, displaying a password field 111 and detecting a finger 151-153 of a hand 150 typing a character may, e.g., be performed by processing means 101, presumably executing an operating system of device 100, in cooperation with touchscreen 110. Further, acquiring an image of the keyboard 112, 312, 412, 512, or 612, ora reflection of the keyboard from camera 120, 420, 520, or 620, may, e.g., be performed by processing means 101, 401, 501, or 601, in cooperation with the camera. Finally, determining which finger of a hand of the user is used for typing the character by analyzing the image, and deriving a respective transformed character from the received typed character based on the finger used for typing the character, is preferably by performed by processing means 101, 401, 501, or 601.

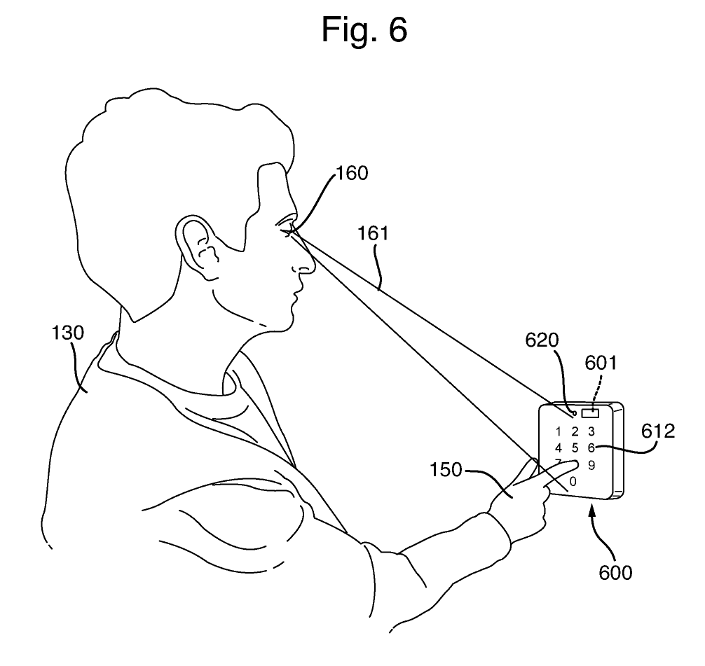

In FIG. 7, an embodiment 700 of processing means 101, 301, 401, 501, and 601, is shown. Processing means 700 comprises a processor 701, e.g., a general purpose processor or a Digital Signal Processor (DPS), a memory 702 containing instructions, i.e., a computer program 703, and one or more interfaces 704 (“I/O” in FIG. 7) for receiving information from, and controlling, touchscreen 110, display 310, 410, or 510, keyboard 312, 412, 512, or 612, and camera 120, 320, 420, 520, or 620, respectively. Computer program 703 is executable by processor 701, whereby device 100, 300, 400, 500, or 600, is operative to perform in accordance with embodiments of the invention, as described hereinbefore with reference to FIGS. 1 to 6.

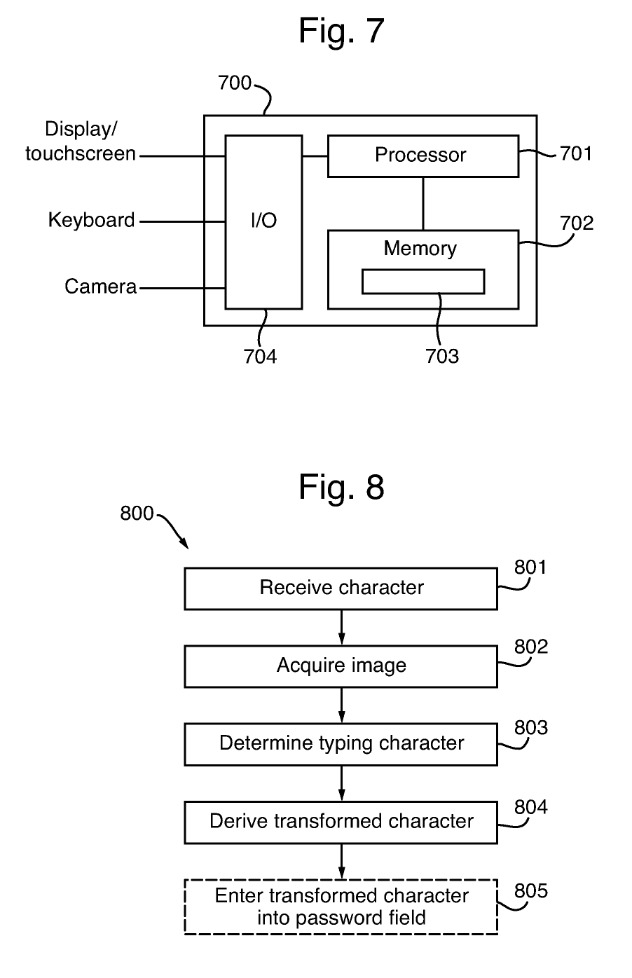

In FIG. 8, a flowchart illustrating an embodiment 800 of the method of authenticating user 130 of a device 100, 400, 500, or 600, is shown.

Method 800 comprises receiving 801 at least one character typed by user 130 using a keyboard 112, 312, 412, 512, or 612, operable as input device for the device. Method 800 further comprises, for each typed character, acquiring an image from camera 120, 420, 520, or 620, configured for imaging the keyboard, determining which finger 151-153 of hand 140 or 150 of user 130 is used for typing the character by analyzing the image, and deriving a respective transformed character from the received typed character based on the finger used for typing the character. The respective transformed character is derived in accordance with what is described with reference to FIG. 2. To this end, deriving the respective transformed character is achieved by implementing an embodiment of transformation algorithm 210. Optionally, method 800 may further comprise entering the respective transformed character into password field 111. That is, the transformed character is entered instead of the typed character, which is intercepted.

It will be appreciated that method 800 may comprise additional, or modified, steps in accordance with what is described hereinbefore. An embodiment of method 800 may be implemented as software, such as computer program 703, to be executed by a processor comprised in the device (such as processor 701 described with reference to FIG. 7), whereby the device is operative to perform in accordance with embodiments of the invention, as described hereinbefore with reference to FIGS. 1 to 6.

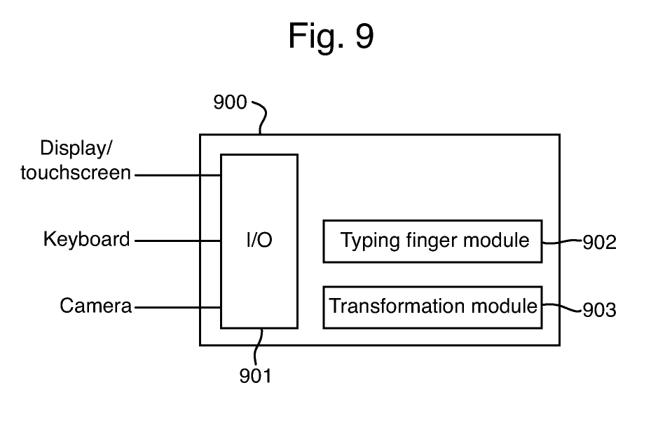

In FIG. 9, an alternative embodiment 900 of processing means 101, 301, 401, 501, or 601, is shown. Processing means 900 comprises one or more interface modules 901 (“I/O” in FIG. 9) for receiving at least one character typed by user 130 using a keyboard 112, 312, 412, 512, or 612, operable as input device for the device, and, for each typed character, acquiring an image from a camera 120, 420, 520, or 620, configured for imaging the keyboard. Processing means 900 further comprises a typing finger module 902 configured for determining, by analyzing the image, which finger 151-153 of hand 140 or 150 of user 130 is used for typing the character, and a transformation module 903 configured for deriving a respective transformed character from the received typed character based on the finger used for typing the character. It will be appreciated that modules 901-903 may be implemented by any kind of electronic circuitry, e.g., any one or a combination of analogue electronic circuitry, digital electronic circuitry, and processing means executing a suitable computer program.

The person skilled in the art realizes that the invention by no means is limited to the embodiments described above. On the contrary, many modifications and variations are possible within the scope of the appended claims. In particular, embodiments of the invention are not limited to the specific choices of algorithms, functions, characters, and fingers, used for exemplifying embodiments of the invention.

1-24. (canceled)

25. A device for authenticating a user, the device comprising:
processing circuitry configured to:
receive at least one character typed by the user as part of a password using a keyboard operable as an input device for the device; and
for each typed character:
acquire an image from a camera configured for imaging a reflection of the keyboard by a cornea of the user;
determine, by analyzing the image, which finger of a hand of the user is used for typing the typed character; and
derive a respective transformed character from the typed character based on the finger used for typing the typed character.

26. The device according to claim 25, wherein the processing circuitry is configured to derive the respective transformed character further based on an identity of the device.

27. The device according to claim 25, wherein the processing circuitry is configured to provide the respective transformed character as input for authentication or access approval.

28. The device according to claim 25, wherein the processing circuitry is configured to display a password field on a display operable as an output device for the device, wherein the user types the at least one character into the password field.

29. The device according to claim 25, wherein the processing circuitry is configured to derive the respective transformed character using an algorithm associated with the finger used for typing the typed character.

30. The device according to claim 25, wherein the processing circuitry is configured to derive the respective transformed character by offsetting or multiplying the typed character by an integer value associated with the finger used for typing the typed character, in accordance with a character table associated with the keyboard.

31. The device according to claim 25, wherein the processing circuitry is configured to derive the respective transformed character by looking up the respective transformed character in a table associated with the finger used for typing the typed character.

32. The device according to claim 25, further comprising a touchscreen, wherein the keyboard is a virtual keyboard displayed on the touchscreen.

33. A method of authenticating a user of a device, the method comprising:
receiving at least one character typed by the user as part of a password using a keyboard operable as an input device for the device; and
for each typed character:
acquiring an image from a camera configured for imaging a reflection of the keyboard by a cornea of the user;
determining, by analyzing the image, which finger of a hand of the user is used for typing the typed character; and
deriving a respective transformed character from the typed character based on the finger used for typing the typed character.

34. The method according to claim 33, wherein the respective transformed character is further based on an identity of the device.

35. The method according to claim 33, further comprising providing the respective transformed character as input for authentication or access approval.

36. The method according to claim 33, further comprising displaying a password field on a display operable as an output device for the device, wherein the user types the at least one character into the password field.

37. The method according to claim 33, wherein the respective transformed character is derived using an algorithm associated with the finger used for typing the typed character.

38. The method according to claim 33, wherein the respective transformed character is derived by offsetting or multiplying the typed character by an integer value associated with the finger used for typing the typed character, in accordance with a character table associated with the keyboard.

39. The method according to claim 33, wherein the respective transformed character is derived by looking up the respective transformed character in a table associated with the finger used for typing the typed character.

40. The method according to claim 33, wherein the device comprises a touchscreen and the keyboard is a virtual keyboard displayed on the touchscreen.

41. A non-transitory computer-readable storage medium storing a computer program for authenticating a user, the computer program comprising computer-executable instructions that, when executed on a processing circuit of a device, cause the device to:
receive at least one character typed by the user as part of a password using a keyboard operable as an input device for the device; and
for each typed character:
acquire an image from a camera configured for imaging a reflection of the keyboard by a cornea of the user;
determine, by analyzing the image, which finger of a hand of the user is used for typing the typed character; and
derive a respective transformed character from the typed character based on the finger used for typing the typed character.
